(19) United States
(12) Patent Application Publication
(10) Pub. No.: US 2007/0217596 A1
(43) Pub. Date: Sep. 20, 2007

(54) Method and system for locally performing local number portability switching at a media terminal device

(76) Inventors: Wade Carter, Snellville, GA (US); Anthony M. Andruzzi, Acworth, GA (US); Bruce McClelland, Alpharetta, GA (US); Ron Miller, Oswego, IL (US); Walter Daniel, Seneca, SC (US)

Correspondence Address: ARRIS INTERNATIONAL, INC, 3871 LAKEFIELD DRIVE, SUWANEE, GA, 30024, US

(21) Appl. No.: 11/688,215

(22) Filed: Mar. 19, 2007

Related U.S. Application Data
(60) Provisional application No. 60/783,511, filed on Mar. 17, 2006.

(51) Int. Cl. H04M 7/00

(52) U.S. Cl. 379/219

(57) ABSTRACT

An integrated user device couples to a user's telephone network, and to multiple service provider networks. A local interface port couples to a local device. When service is transferred from an old provider to a new provider, a message is received at the integrated user device. Processing circuitry in the user device processes the message and causes switching components in the user device to decouple the telephone network from the old service provider's network and to couple to the new provider's network. The message may be received from the new provider's network or from the local interface port.

The message may be an SNMP MIB, a ring signal or a command line interface message; delivery may be via DOCSIS, PacketCable, SIP, or other method. The switching processing components may include relay coils in an alternating arrangement coupled to a source node and to separate relay driver pins of a SLIC.

### CROSS REFERENCE TO RELATED APPLICATION

This application claims the benefit of priority under 35 U.S.C. 119(e) to the filing date of Carter, et al., U.S. provisional patent application No. 60/783,511 entitled “Integration of a local number portability (LPN) switch into an EMTA,” which was filed Mar. 17, 2006, and is incorporated herein by reference in its entirety.

### FIELD OF THE INVENTION

This invention relates, generally, to communication networks and, more particularly, for facilitating switching between networks and their respective associated user devices while retaining the same user identifier in sending and receiving telephony sessions.

### BACKGROUND

Currently, broadband networks may be used to provide traditional telephony service over community antenna television (“CATV”) or other communications networks using coaxial cable (“coax”) or optical fiber cable. For example, ARRIS Group, Inc. offers telephone over cable products known as VOICE PORT® and TOUCHSTONE® cable modems which interface a media terminal adaptor (“MTA”), or an embedded media terminal adaptor (“EMTA”), with a data network.

Since many potential users/subscribers of telephony services over internet, often referred to as Voice Over Internet Protocol (“VoIP”), currently subscribe to telephony service from traditional telephone carriers, often referred to as Incumbent Local Exchange Carriers (“ILEC”) and Competitive Local Exchange Carriers (“CLEC”), service providers offering VoIP service need to make switching to their services as trouble-free as possible. A problem in the past in switching from one telephony carrier to another (e.g., switching from an ILEC to a CLEC) is that the customer would usually have to relinquish their subscriber identifier (i.e., telephone number) when switching to the new carrier. However, through market forces and legislative action, carriers have implemented Local Number Protability (“LNP”) so that when a subscriber changes providers, they retain their same telephone number.

In addition to implementing LNP between traditional telephone carriers, LNP is also implemented when a subscriber changes from a traditional carrier to a VoIP carrier, from a VoIP carrier back to a traditional carrier or between VoIP carriers. When the change is between network types, a switching device is typically used to disconnect the subscriber's device, or devices, from the old service provider's network and connect the device(s) to the new service provider's network.

A switch may not be necessary if, for example, the internetwork that will provide the internet protocol connection for which the VoIP traffic will be carried is a digital subscriber line (“DSL”). This is because tradition telephony service and DSL are typically provided over the same physical connection. However, if a subscriber is switching between a service provider that provides service over traditional twisted pair cable and coupled to an ILEC or CLEC central office to a provider that provides service over a hybrid fiber coaxial network. (“HFC”), for example, such as a CATV provider, often referred to as a multiple services provider (“MSO”), the MSO may not know when the old provider discontinues service. Thus, a subscriber may experience delays, often days, between discontinuation of service from the Local Exchange Carrier (“LEC”) and commencement of service from the MSO. In addition, the MSO typically needs to verify with the Service Order Administration (“SOA”) database that the subscriber's number has been released by the old carrier, but has not been released for other carriers to use except for the subscriber who has most recently used the number. The subscriber's telephone number needs to be released from the SOA by the old carrier before the number can be associated with the MSO's subscriber's premise devices. When this association is confirmed, a technician is scheduled to physically travel to the subscriber's location, configure and connect a customer premise device to the subscribers telephone devices and ensure that dial tone is available and that the devices are operational. This trip to the customer's location may be a second trip by a technician that follows a first trip to physically install other equipment, such as video set top box, internet connectivity, etc.

To reduce the need for the second trip, MSO's have utilized external switches that can connect an EMTA device to either a link from a LEC or a link from an MSO. An example of a switch currently used in the art is shown in FIG. 1. Switch device 2 includes relay section 4. Relay section 4 switching tip and ring lines going to a phone, or phone network in a home or office building via phone port 6. Relay portion 4 switches between signals received on a LEC link coupled to LEC port 8 or on an MSO link coupled to EMTA port 10. Charge pump relays 12 and 13 connect either charge pump 16 or charge pump 18, respectively, to either SCR trigger 20 or 22, respectively. SCR triggers 20 and 22 trigger either SCR switch 24 or 26 respectively. SCR switches 24 and 26 energize either relay coil 28 or 30. Depending on which relay coil, either 28 or 30, is energized, all the relays, including those in relay section 4, and charge pump relays 12 and 14, are in either an A position or a B position. Position A occurs when relay coil 28 energizes and position B occurs when relay coil 30 energizes. In the figure, all relays are shown in the A position. Position A corresponds to a path between EMTA port 10 and Phone port 6 being made, which a path between ILEC port 8 and phone port 6 being broken. Charge stores in pumps 16 and 18 when a ring signal is present at port 10 or port 8, respectively. Thus, for example, in the figure, if a ring signal were present at port 8, with relay 14 in position A as shown, for example if a customer switched phone service from an MSO to an ILEC, then charge would build up in pump 18 until SCR Trigger 22 caused the SCR Switch 26 to energize Relay Coil 30 causing relay 14 to change from the A position to the B position. Consequently, switch 12 would switch positions (to a position that would await incoming charge from port 10) and the relays in relay portion 4 would also change to position B connecting the ILEC port 8 to the Phone port 6.

Although effective in facilitating automatic switching a user's phone network from one provider's network to another, switch 2 is external to a typical cable modem, MTA or EMTA device. Thus, there is a need in the art for a method and system for automatically switching a subscriber's phone, or phones, from one provider's network to another upon detection that service is available on the network to be switched to.

Furthermore, there is a need in the art for a method and system for automatically switching that is integrated into an EMTA device.

### BRIEF DESCRIPTION OF DRAWINGS

FIG. 1 illustrates a block diagram for an external auto-detect switching means.

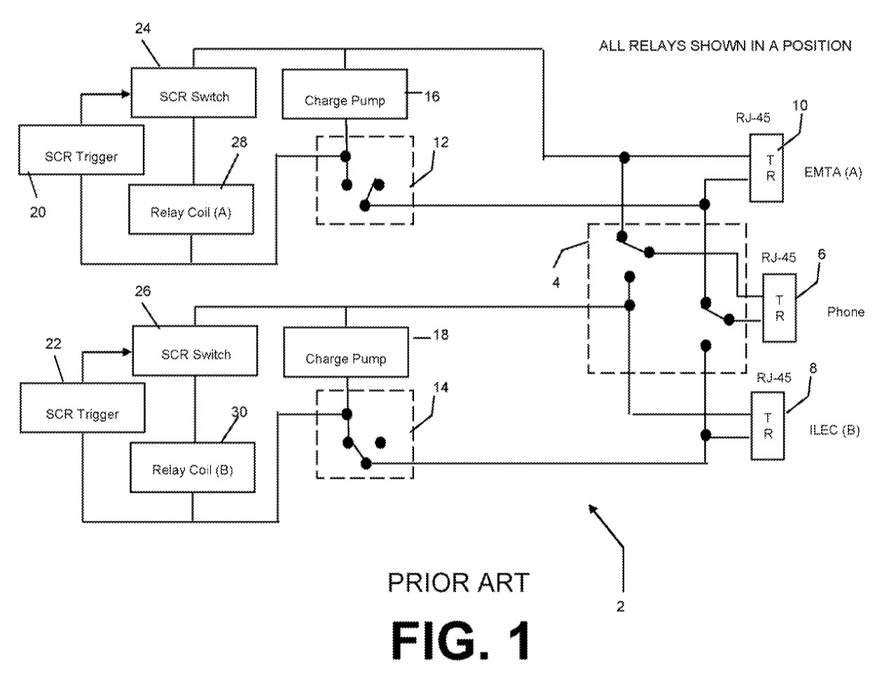

FIG. 2 illustrates a block diagram for an auto-detect switching means integrated into an EMTA device configured for ILEC operation.

FIG. 3 illustrates a block diagram for an auto-detect switching means integrated into an EMTA device configured for MSO operation.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

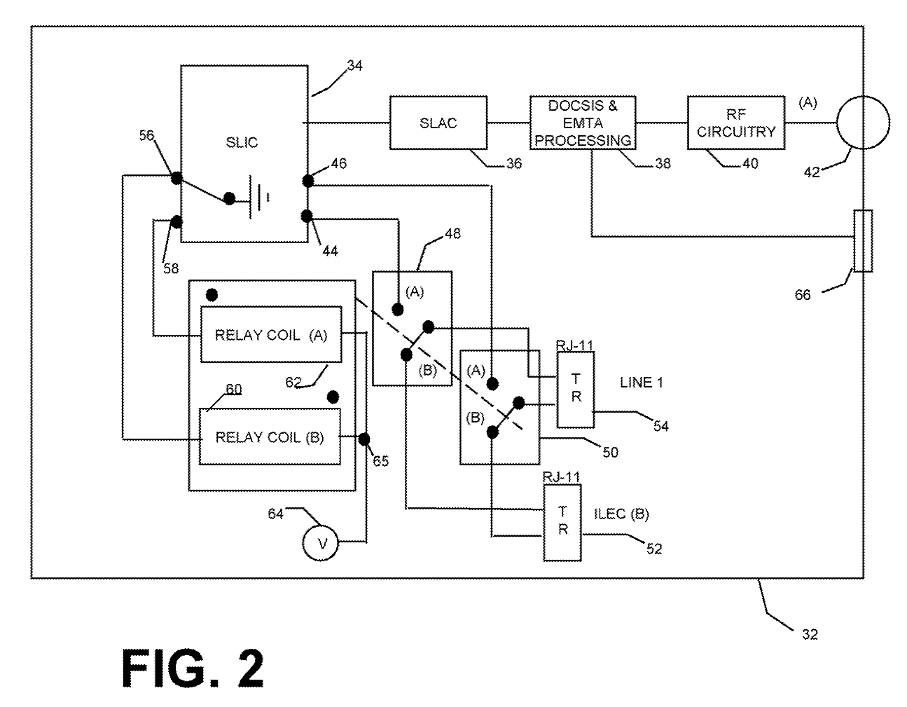

Turing now to the figures, FIG. 2 illustrates a block diagram for an auto-detect switching means integrated into an integrated EMTA device 32 configured for ILEC operation. As known in the art, an EMTA device typically comprises means for processing various signals and messages. The processing means typically includes a subscriber line interface circuit (“SLIC”) that provides an interface between a call signal that is output from a subscriber line access circuit (“SLAC”) 36. The SLAC couples to an EMTA processor 38, typically a dual processor arrangement with a communications processor and a digital signal processor (“DSP”), that may couple to a radio tuner circuit 40 that sends and receives quadrature amplitude modulation signals (“QAM”) to and from an MSO HFC network at the MSO network connection port 42, and provides a local interface at local interface port 66. It will be appreciated that the EMTA processor 38 includes a Data Over Cable Service Interface Specification (“DOCSIS”) Media Access Control (“MAC”) and Physical (“PHY”) layers, and related components as known in the art. In addition, it will be appreciated that integrated device 32 includes ports 42, 52, 54 and 66. Reference to the phrase processing means includes reference to RF circuitry 40, DOCSIS and EMTA processing components 38, SLAC 36 and SLIC 34, in addition to other ancillary and supporting components that are not shown in the figures for clarity.

SLIC 34 includes tip connection 44 and ring connection 46, which both couple to a conventional telephony device as known in the art. Tip relay contact 48 and ring relay contact 50 are shown in a position in FIG. 2 that respectively couple tip and ring connection points of ILEC network connection port 52 to telephony line connection port 54. Thus, device 32 is configured to couple a user's telephone or telephones to an ILEC's network.

It will be appreciated that in FIG. 2, pin 56 is shown grounded. This state would typically have occurred after a switching message, such as a command from a local EMTA user interface via port 66 or a remote message via port 42 received from the MSO instructing device 32 to switch ports to which line connection port is connected. The grounding operation that may be programmed into SLIC 34 occurs in response to the switching message received via the MSO and is typically momentary—enough time to send a pulse signal to second relay coil 60. Therefore, it will be understood that pin 56 was momentarily grounded before relays contacts 48 and 50 attained their positions shown in FIG. 2.

The momentary pulse occurs because a voltage that is always present at source 64 (a voltage source pin, for example), and thus supply node 65, creates a path to ground through normally open, or high impedance, relay driver pin 56. The pulse momentarily flows through pin 56 and then the relay driver pin returns to its normally open, or high impedance state.

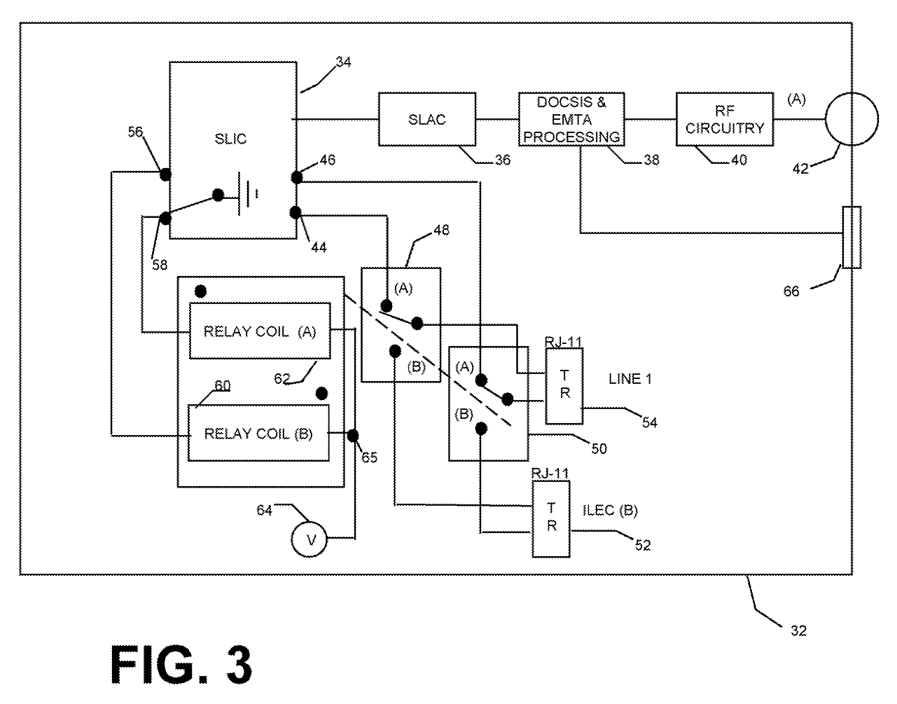

When device 32 is configured as shown in FIG. 2, a message received via port 42 from an MSO's head end can automatically initiate a change in positions of relay contacts 48 and 50 so that a user's telephone or telephones are coupled to the MSO's network rather than to ILEC port 52. The arrangement of relay contacts 48 and 50, and the momentary grounding of pin 58 is shown in FIG. 3.

Turning now to FIG. 3, a message received from an MSO head end via HFC port 42 is typically demodulated by RF circuitry 40 as known in the art. For example, a ring signal may be received via port 42, demodulated by tuner 40 and processed by processor 38. The ring signal is then sent through SLAC 36 to SLIC 34. SLIC 34 may be configured to ground relay driver pin 58 in response to the ring signal message. As discussed above, SLIC may be programmed to ground the pin momentarily in response to the ring message received from the MSO head end, thus sending a pulse through first relay coil 62. When the current pulse flows through relay coil 62, relay contacts 48 and 50 change from the B position to the A position as shown in the FIG. 3.

It will be appreciated that in the preferred embodiment, relay coils A and B are inversely arranged with respect to the voltage source 64 as indicated by the current-alignment dots. The relay coils are typically mounted to a common plunger. Thus, when driver pin 56 is momentarily grounded, the pulse causes relay coil 60 to energize and move the common plunger a second direction. This in turn causes contacts B of relay contacts 48 and 50 to connect with the tip and ring points, respectively, on phone port 54. Conversely, when pin 58 is momentarily grounded, the pulse causes relay 62 to energize and move the common plunger a first direction which causes contacts A of relay contacts 48 and 50 to make contact with the tip and ring points, respectively, of phone port 54. Thus, depending on whether a message received from MSO port 42 is to connect a user's telephone or telephones to an ILEC's network or an MSO's network port 52, already-existing relay driver pins 56 and 58 are used to facilitate automatic switching from one network to the other.

As discussed above, the switching massaging may be a command from a local EMTA user interface via port 66, such as, for example, an Ethernet port, USB port, or Firewire port, or a message from an MSO's head end equipment, such as, for example, a VoIP soft switch or network management system. The ring message from the MSO may be a telephony over IP message that causes the SLIC to ring. Alternatively, since the components shown in FIGS. 2 and 3 are integrated into a single device that also includes cable modem circuitry and processing, such as, for example, DOCSIS circuitry and processing components, the message that causes relays 48 and 50 to change positions may be a Simple Network Management Protocol (“SNMP”) management information base (“MIB”) message. Thus, the message sent from the head end could be a telephony signaling message sent according to the PacketCable or Session Initiated Protocol (“SIP”) standards, or a management message sent via SNMP. It will be appreciated the message sent from the head end can instruct components in device 32 to switch from ILEC connection, which is scenario B in the figures, to the MSO connection, which is scenario A in the figures.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A system for initiating automatic switching of a phone network coupled to a telephony line connection port between connection with a first provider's network connection port and connection with a second provider's network connection port, comprising:
an integrated user device having a telephony line connection port for coupling a telephony network, a first provider's network connection port for coupling to a first provider's communication network and a second provider's network connection port for coupling to a second provider's communication network; and
means for processing a switching message instructing the integrated user device to couple tip and ring points of the telephony line connection port to corresponding tip and ring points of either the first provider's network connection port or the second provider's network connection port, wherein the means for processing is integrated into the user device.

2. The system of claim 1 wherein the first provider is an ILEC or CLEC.

3. The system of claim 1 wherein the second provider is an MSO.

4. The system of claim 1 wherein the means for processing includes a relay driver coupled to relay driver pins on a SLIC.

5. The system of claim 4 wherein the means for processing further includes inversely arranged first and second relay coils wherein an end of the first relay coil is connected to the inverse end of the second relay coil at a supply node, which is connected to a source, the other ends of the first and second relay coils being coupled to the corresponding relay driver pins.

6. The system of claim 5 wherein the first and second relay coils urge a common plunger to connect tip and ring points of the telephony line connection port with corresponding tip and ring points of the first provider's network connection port when the end of the first relay coil opposite the supply node is grounded via the relay driver pin to which it is coupled.

7. The system of claim 5 wherein the first and second relay coils urge a common plunger to connect tip and ring points of the telephony line connection port with corresponding tip and ring points of the second provider's network connection port when the end of the second relay coil opposite the supply node is grounded via the relay driver pin to which it is coupled.

8. The system of claim 1 further comprising a local interface means for receiving local messages that is integrated into the user device and coupled to the processing means.

9. A method for initiating automatic switching of a phone network coupled to a telephony line connection port between connection with a first provider's network connection port and connection with a second provider's network connection port, comprising:
instructing an integrated user device via a switching message to couple tip and ring points of the telephony connection port to corresponding tip and ring points of either the first provider's network connection port or the second provider's network connection port, wherein the switching message may be generated either locally or remotely.

10. The method of claim 9 wherein the message is a ring message sent from the second provider as a telephony over IP message.

11. The method of claim 10 wherein the message is received via the second provider's network connection port.

12. The method of claim 9 wherein the message is an SNMP MIB message.

13. The method of claim 9 wherein the message is sent via PacketCable.

14. The method claim 9 wherein the message is sent via DOCSIS.

15. The method of claim 9 wherein the message is sent via SIP.

16. The method of claim 9 wherein the message is received via a local interface port.
